(19) United States
(12) Patent Application Publication
(10) Pub. No.: US 2007/0157270 A1
(43) Pub. Date: Jul. 5, 2007

(54) Receiving apparatus using non-volatile memory and method of operating the same

(76) Inventor: Sean S. Lee, Potomac, MD (US)

Correspondence Address: THE DIRECTV GROUP INC, PATENT DOCKET ADMINISTRATION RE/R11/A109, P O BOX 956, EL SEGUNDO, CA, 90245-0956, US

(21) Appl. No.: 11/353,584

(22) Filed: Feb. 14, 2006

Related U.S. Application Data
(60) Provisional application No. 60/754,555, filed on Dec. 28, 2005.

(51) Int. Cl. H04N 7/173; H04N 5/50; H04N 5/445

(52) U.S. Cl. 725/100; 725/131; 348/731; 725/39; 725/134

(57) ABSTRACT

A mobile receiving unit (28) may be coupled to an antenna (26) for receiving various information. A tuner (64) receives the information such as program guide data from the antenna and provides it to controller (60). Controller (60) may be coupled to a non-volatile memory (74). The non-volatile memory (74) may be used to store information such as a program guide. The program guide may operate from a dynamic memory (72). The non-volatile memory (74) thus saves the information so that the program guide does not need to be reloaded from broadcast data upon a reboot of the system. The program guide data may be loaded from non-volatile memory (74) upon a reboot.

### TECHNICAL FIELD

The present invention relates generally to a satellite receiving device, and more specifically, to a method and apparatus to store certain information such as a program guide in a non-volatile memory.

### BACKGROUND

Satellite television has become increasingly popular due to its wide variety of programming. Entertainment in automobiles such as DVD players has also become increasingly popular. It would be desirable to provide a satellite television system for a vehicle so that the wide variety of programming may be enjoyed by the rear passengers.

In a typical satellite receiver box or integrated receiver/decoder (IRD) information such as guide information is typically stored in volatile memory. In volatile memory, data is lost when the power is lost. Guide information is typically stored in the volatile memory. The guide information encompasses everything from program descriptions to channel tuning parameters. Traditional set top boxes that utilize program guide information load the program into dynamic memory upon boot up or power up. The information is acquired from an outside source such as the incoming satellite data stream. The outside source may be a data stream that the set top box acquires. The program guide data is stored in volatile memory such that each time the set top box reboots, the data must be loaded again. Loading the guide data information takes a noticeable amount of time and most set top boxes require a significant portion of the guide information before normal operation may start.

It would therefore be desirable to provide a method and apparatus for storing program guide or other information and non-volatile memory to provide faster operation after powering the device, or rebooting or resetting of the device.

### SUMMARY OF THE INVENTION

The present invention provides a non-volatile memory for storing important information such as the program guide. In a mobile application, this is important to reduce the start time of the system after the power cycle. In a mobile application the power may be cycled often compared to conventional home-based type systems.

In a home-based system, providing flash memory also provides the advantage of easy start up. Another advantage of providing flash memory in a home-based system is that calls to the customer support department will be reduced since rebooting the system is often used to troubleshoot problems. The reduced start time will allow the customer service support department to spend less time on the telephone and thus reduce costs per call.

In one aspect of the invention, a receiver unit includes a tuner, a non-volatile memory, and a controller coupled to the non-volatile memory and the tuner. The controller receives information from the tuner and stores the information in the non-volatile memory.

In a further aspect of the invention, a receiving unit comprises a tuner receiving a signal, a demodulator demodulating the signal to form a demodulated signal. A decoder is coupled to the demodulator decoding the demodulated signal to form a decoded signal. The decoded signal comprises program guide information. A flash memory is coupled to a controller. The controller receives the program guide information and stores the information in the flash memory.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a system level view of a satellite broadcasting system according to the present invention.

FIG. 2 is a block diagrammatic view of a vehicle having a receiving system according to the present invention.

FIG. 3 is a flow chart illustrating a method of storing a channel in flash memory according to the present invention.

FIG. 4 is a flow chart illustrating a method for storing programs in a flash memory according to the present invention.

FIG. 5 is a flow chart illustrating a method of removing non-relevant data from flash memory according to the present invention.

FIG. 6 is a flow chart illustrating a method of loading program guide data from dynamic memory to flash memory according to the present invention.

### DETAILED DESCRIPTION

In the following figures the same reference numerals will be used for the same views. The following figures are described with respect to a mobile satellite television system. However, those skilled in the art will recognize the teachings of the present invention may be applied to various types of mobile reception including various land, airborne and water-based type systems.

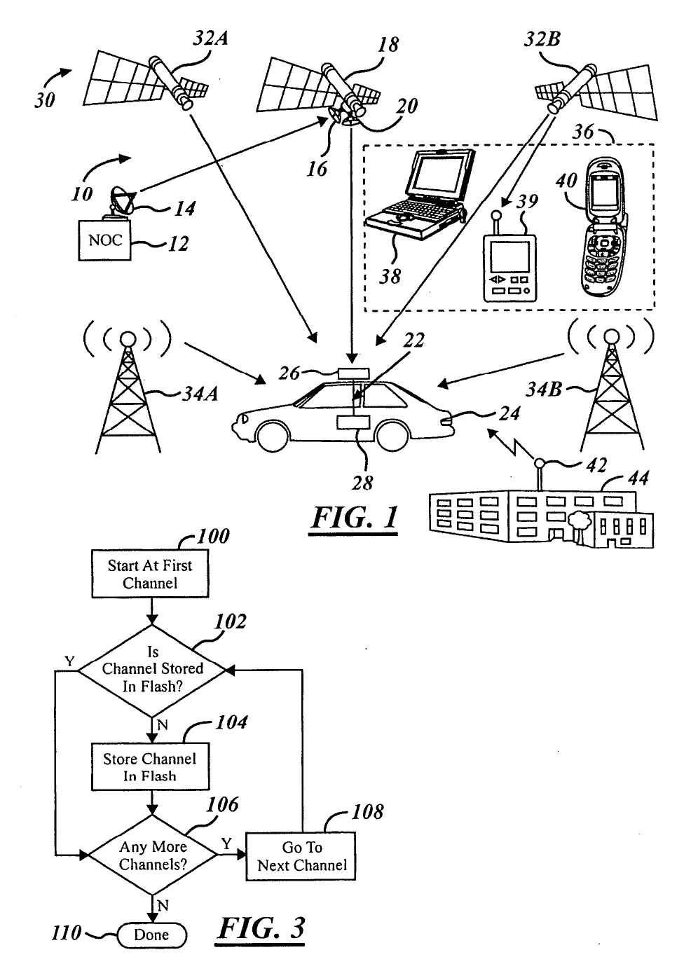

Referring now to FIG. 1, a satellite television broadcasting system 10 is illustrated. The satellite television broadcasting system 10 includes a network operations center 12 that generates wireless signals through a transmitting antenna 14 which are received by a receiving antenna 16 of a satellite 18. The wireless signals, for example, may be digital. A transmitting antenna 20 generates signals directed to various receiving systems including stationary systems such as those in the home as well as mobile receiving systems 22. The wireless signals may have various types of information associated with them including location information. The wireless signals may also have various video and audio information associated therewith. As illustrated, the mobile receiving system 22 is disposed within an automotive vehicle 24. A receiving antenna 26 receives the wireless signals from the satellite 18 and processes the signals in a mobile receiving unit 28. The mobile receiving unit 28 will be further described below.

The system 10 may also receive location signals from a GPS system 30 that includes a first satellite 32A and a second satellite 32B. Although only two satellites are shown, a typical GPS system includes several satellites, several of which may be in view at any particular time. Triangulation techniques may be used to determine the elevation, latitude and longitude of the system. A locating system may also include cellular towers 34A and 34B that may be used by the mobile receiving system 22 to determine a location. Cellular phones typically include a GPS locating system. As the vehicle 24 moves about, the exact coordinates in latitude and longitude may be used to determine the proper designated marketing area for local television and broadcasting.

The present invention may also be used for displaying various wireless information on a personal mobile device 36 such as a laptop computer 38, a personal digital assistant 39, and a cellular telephone 40. It should be noted that these devices and the automotive-based devices may also receive wireless signals having various types of information associated therewith from the cellular towers 34A and 34B. Other types of information may be broadcast from various other types of broadcasting areas such as an antenna 42 on a building 44. The building 44 may be various types of buildings such as a store and the wireless information transmitted from the antenna 42 may be advertising information. All of the wireless signals preferably include location information transmitted therewith. As will be described below, the information may be coded digitally into the signals. Thus, by reviewing the location information, signals appropriate for the location of the mobile devices may be displayed on the various devices. This will be further described below.

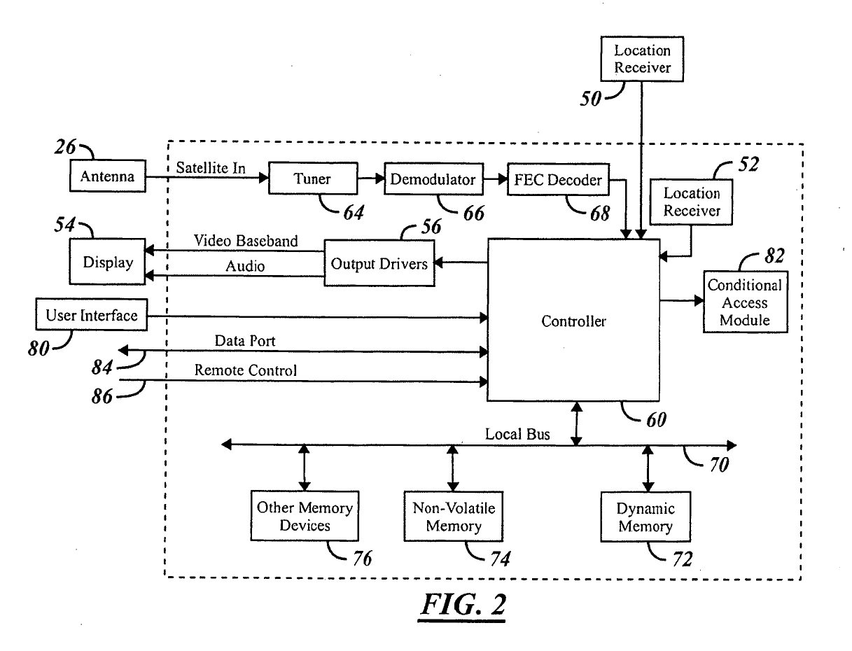

Referring now to FIG. 2, a receiving unit 22 is illustrated in further detail. Antenna 26 may be various types of antennas including a rotating antenna which is used to track the relative movement of the satellite or other transponding device with respect to the vehicle. The antenna 26 may be a single antenna used for satellite television reception, or a number of antennas such as one for receiving television signals and one coupled to a GPS location receiver 50. The antenna 26 may also be an electronic antenna.

The mobile receiver unit 28 is coupled to antenna 26. The mobile receiving unit 28 may also include a location receiver 52 integrated therein. The location receiver 52 may be a GPS receiver. In a preferred embodiment, only one location receiver 50, 52 may be provided in the system. However, the location receiver 50, 52 may be part of the vehicle 24 or may be part of the mobile receiving system 22, 36. The controller 60 may be coupled directly to location receiver 52 and/or location receiver 50. The mobile receiving unit 28 includes a display 54. The display 54 may be incorporated into the device 36 or within the vehicle 24. The display 54 may include output drivers 56 used for generating the desired audio and video outputs suitable for the particular display 54.

A controller 60 may be a general processor such as a microprocessor. The controller 60 may be used to coordinate and control the various functions of the receiving unit 28. These functions may include a tuner 64, a demodulator 66, a forward error correction decoder 68 and any buffers and other functions. The timer 64 receives the signal or data from the individual channel. The demodulator 66 demodulates the signal or data to form a demodulated signal or data. The decoder 68 decodes the demodulated signal to form decoded data or a decoded signal. The controller 60 may be similar to that found in current DirecTV set top boxes which employ a chip-based multifunctional controller.

The controller 60 may include or be coupled to a local bus 70. The local bus 70 may be used to couple a dynamic memory 72 such as RAM which changes often and whose contents may be lost upon the interruption of power or boot up. The bus 70 may also be coupled to a non-volatile memory 74. The non-volatile memory may be an in-circuit programmable type memory or a hard disk drive. One example of a non-volatile memory is an EEPROM. One specific type of EEPROM is flash memory. Flash memory is suitable since it is sectored into blocks of data segments that may be individually erased and rewritten.

Other memory devices 76 may also be coupled to local bus 70. The other memory devices may include other types of dynamic memory, non-volatile memory, or may include such devices such as a digital video recorder. The display 54 may be changed under the control of controller 60 in response to the data in the dynamic memory 72 or non-volatile memory 74.

The controller 60 may also be coupled to a user interface 80. User interface 80 may be various types of user interfaces such as a keyboard, push buttons, a touch screen, a voice activated interface, or the like. User interface 80 may be used to select a channel, select various information, change the volume, change the display appearance, or other functions. The user interface 80 is illustrated as part of the mobile receiving unit. However, should the unit be incorporated into a vehicle, the user interface 80 may be located external to the mobile receiving unit such as dial buttons, voice activated system, or the like incorporated into the vehicle and interface with the mobile receiving unit.

A conditional access module card 82 (CAM) may also be incorporated into the mobile receiving unit. Access cards such as a conditional access module (CAM) cards are typically found in DirecTV units. The access card 82 may provide conditional access to various channels and wireless signals generated by the system. Not having an access card or not having an up-to-date access card 66 may prevent the user from receiving or displaying various wireless content from the system.

A data port 84 may be coupled to the controller 60 for transmitting or receiving information from a device. A remote control 86 may be used as one type of interface device. The remote control 86 provides various data to the controller 60.

Referring now to FIG. 3, the program guide information is formed of units of data that typically represent channels and programs. The channels consist of parameters for a device to determine a video source and display the video on the screen such as satellite tuning parameters (e.g. transponder location). Programs are used to represent video that is available. Traditionally they include data such as a textual description of the video, start and stop times, and additional descriptions such as category and ratings. Typically, the program data includes channel information. Each channel has a set of programs that are broadcast at different times. Various algorithms may be applied to determine what programming guide information is to be stored in the non-volatile memory. For example, all channel related data may be included. For some configurations, it may be desirable to store all program guide data that is in volatile memory to a non-volatile memory such as flash memory. The memory in this and the following examples is flash memory. However, various types of non-volatile memory may be used. A time window style algorithm may be used. In the following figure all the channel data will be stored for all channels for the particular service. In other configurations only some of the available channel information may be stored. In step 100, the system starts at the first channel. If the channel information is not stored in flash memory, step 104 is implemented which stores the channel information in flash memory. In step 106, if there are any more channels, step 108 is implemented which goes to the next channel. After step 108 the system returns to step 102 to determine if the next channel is stored.

In step 102, if the channel is stored in flash memory, step 106 is implemented which determines if more channels exist. In step 106, if there are no more channels the system is done in step 110.

Referring now to FIG. 4, it may be desirable to set time windows for storing the various information. In step 120, the system starts at the first program of the channel. Because program guide data is time relevant and new programming information may be constantly broadcast, the algorithms may need to be run periodically to store the latest programming information. In step 120, the system starts at the first program of a channel. In step 122, if the program is not stored in flash memory, step 124 is executed. In step 124 it is determined whether the program airs in the time window. If the program does air in the time window, step 126 is implemented in which the program is stored in the memory which may be flash memory. After step 126, step 128 determines if there are any more programs. If there are no more programs in step 128, step 130 is executed in which the system is done. In step 128, if there are more programs, the next program is sought in step 132 and the system returned to step 122. In step 122, if the program is stored in flash memory or in step 124 if the program does not air in the time window, step 128 is executed. It should be noted that the system preferably receives the data and stores the data in dynamic memory then compares the dynamic memory to the flash memory in the above comparison. Therefore, the dynamic memory may act as a buffer for the program guide information. Also, the time window in step 124 may be various times such as two hours from the current time. If the program start time and end times intersect with the current time and current time plus two hours, the program may be written to flash memory. Various aspects of flash memory may be taken into account in the writing of the flash memory. The properties of flash memory are well documented and many solutions exist to address flash file systems. The program guide may be written to the flash memory in such a way that if the device were to stop functioning unexpectedly, other units of the program guide may be uncorrupted and may be read upon the next power up of the device.

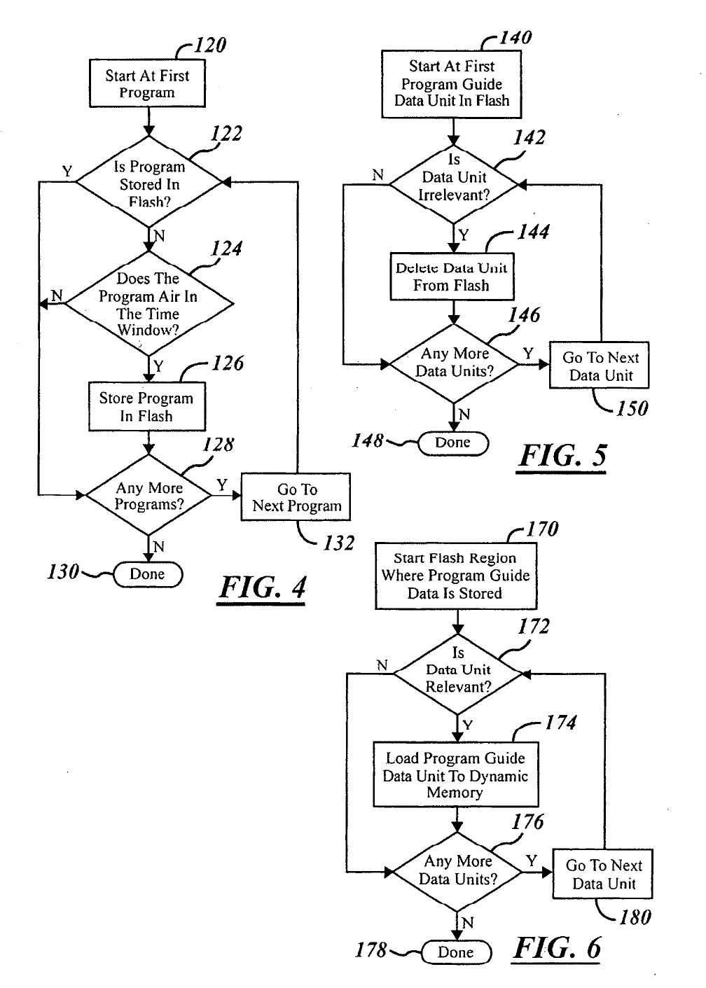

Referring now to FIG. 5, the obsolete program guide data may be periodically deleted. Deletion may be initiated from the broadcast to specifically have program guide data removed from the memory. Also, some program guide data that is stored in the flash memory has time relevance and should be deleted when it refers to events in the past. To accomplish this, a scan may be performed periodically so as to free up memory space for new program guide information to be written. In step 140, the system starts at the first program guide data in the flash memory. In step 142, it is determined whether or not the data unit is irrelevant. A data unit may be irrelevant if the time period has passed. In step 144, if the unit is irrelevant, step 144 deletes the unit from the flash and in step 146 the existence of any other data units is determined. If no more data units exist the system ends in step 148.

In step 146 if there are more data units, step 150 goes to the next data unit. In step 142, if the data unit is relevant, the system jumps to step 146 to determine if there are any more data units.

Referring now to FIG. 6, the system may store the program guide data in the flash memory whereas the information may be transferred from the flash memory to the dynamic memory for use. It should be noted that the flash memory may store information other than program guide data. In step 170, this flash region where the program guide data is stored is scanned. In step 172, if the data unit is relevant, step 174 loads the program guide data unit to the dynamic memory. In step 176, if no more data units are available step 178 ends the process. In step 176, if more data units are available step 180 goes to the next data unit. Referring back to step 172, if the data unit is not relevant step 176 is again executed.

Thus, after performing the loading of the program guide data from flash memory, the receiving device may immediately present program guide information to the user and be ready for normal operation without waiting to load program guide data from the broadcasted data stream. This takes place in a very rapid manner compared to loading from a broadcasted stream.

While particular embodiments of the invention have been shown and described, numerous variations and alternate embodiments will occur to those skilled in the art. Accordingly, it is intended that the invention be limited only in terms of the appended claims.

What is claimed is:

1. A receiving unit comprising:
a tuner;
a non-volatile memory; and
a controller coupled to the non-volatile memory and the tuner, said controller receiving information from the tuner and storing the information in the non-volatile memory.

2. A receiving unit as recited in claim 1 wherein the memory comprises a flash memory.

3. A receiving unit as recited in claim 1 wherein the memory comprises an EEPROM.

4. A receiving unit as recited in claim 1 wherein the memory comprises a hard disk.

5. A receiving unit as recited in claim 1 wherein the information comprises a program guide.

6. A receiving unit as recited in claim 1 further comprising a dynamic memory, said controller storing the information in the dynamic memory, comparing the dynamic memory with the non-volatile memory and storing the information in the dynamic memory in the non-volatile memory in response to comparing.

7. A receiving unit as recited in claim 1 wherein said controller sets a time window; and wherein the controller stores the information when the information is within the time window.

8. A receiving unit as recited in claim 1 further comprising a dynamic memory, said controller transferring data from the non-volatile memory to the dynamic memory and said controller operating a screen display using the data in the dynamic memory.

9. A receiving unit as recited in claim 1 wherein the tuner comprises a satellite television tuner.

10. A receiving unit comprising:
a tuner receiving a signal;
a demodulator demodulating the signal to form a demodulated signal;
a decoder coupled to the demodulator decoding the demodulated signal forming a decoded signal, said decoded signal comprising program guide data;
a flash memory;
a controller coupled to the flash memory, said controller receiving the program guide information and storing the program guide data in the flash memory.

11. A receiving unit as recited in claim 10 further comprising a dynamic memory, said controller storing the information in the dynamic memory, comparing the dynamic memory with the flash memory and storing the program guide data in the dynamic memory in the flash memory in response to comparing.

12. A receiving unit as recited in claim 10 wherein said controller sets a time window and, the controller stores the program guide data when the information is within the time window.

13. A receiving unit as recited in claim 10 further comprising a dynamic memory, said controller transferring program guide data from the non-volatile memory to the dynamic memory and said controller operating a screen display using the data in the dynamic memory.

14. A receiving unit as recited in claim 10 wherein the tuner comprises a satellite television tuner.

15. A method of operating a receiving device comprising:
storing program guide data in a non-volatile memory;
rebooting a receiver unit;
retrieving the program guide data from the non-volatile memory;
storing the program guide data into a dynamic memory; and
operating program guide display from the dynamic memory.

16. A method as recited in claim 15 wherein rebooting comprises clearing the dynamic memory.

17. A method as recited in claim 15 wherein the memory comprises a flash memory.

18. A method as recited in claim 15 wherein the memory comprises an EEPROM.

19. A method as recited in claim 15 wherein the memory comprises a hard drive.

20. A method comprising
receiving channel data;
receiving program data for the channel; and
storing the program data and channel data in a non-volatile memory.

21. A method as recited in claim 20 further comprising setting a time window; and
wherein the step of storing the program data comprises storing the program data when the program data is within the time window.

22. A method as recited in claim 20 wherein receiving channel data comprises receiving channel data from a satellite.

23. A method as recited in claim 20 wherein receiving program data comprises receiving program data from a satellite.

24. A method comprising:
obtaining a data unit from a non-volatile memory;
determining when a data unit is relevant when the data unit corresponds to a past event;
deleting a data unit when the data unit corresponds to the past event.

25. A method as recited in claim 24 wherein the data unit comprises program guide data.
